(19) United States
(12) Patent Application Publication
(10) Pub. No.: US 2008/0235205 A1
(43) Pub. Date: Sep. 25, 2008

(54) Database Search Results User Interface

(76) Inventors: Gene S. Fein, Lenox, MA (US); Edward Merritt, Lenox, MA (US)

Correspondence Address: Stolowitz Ford Cowger LLP, 621 SW Morrison St, Suite 600, Portland, OR, 97205, US

(21) Appl. No.: 11/677,406

(22) Filed: Feb. 21, 2007

(51) Int. Cl. G06F 7/06; G06F 17/30; G06F 3/048

(52) U.S. Cl. 707/5; 707/E17.015; 715/764; 707/E17.014

(57) ABSTRACT

A system and method for retrieving and displaying search results by retrieving a user's search results from a database and providing an interface with which the user scrolls through the search results. The system and method approximate a rate at which the user scrolls through the search results based on at least one user action, and retrieves additional search results from the database based on the approximated rate. The system and method display the search results on a display device in predetermined patterns of screen positions in cooperation with the navigation/scroll control interface.

### FIELD OF THE INVENTION

The present invention relates to the creation of a screen scrolling control system that allows for more efficient retrieval and display of search results from a database via a rapid data and scrolling interface using intuitive and flexible activation of the scrolling mechanisms for swift and efficient retrieval and identification of results.

### BACKGROUND OF THE INVENTION

It is well known that conducting a search for information online can be an effective way to find information. Millions of people each day use search engines and mechanisms such as Google.com's searching function to locate, or attempt to locate, specific data online.

Traditional search processes yield a set of results through which a user may browse, with a predetermined number of results returned by the search engine and made available for display on a single page. To browse the next set of results generated by the search engine (i.e., numbers of results greater than the predetermined number) the user must click on a “next page” icon or select a specific page number from many pages to skip to that specific page. When browsing through the pages of search results, the user may utilize a right margin scroll bar, and sometimes the mouse wheel, to scroll through the single page of results. Some search mechanisms allow for a relatively large amount of results on a single page, such as one hundred results, as opposed to about ten results for smaller search result return pages. Google, for instance, allows a user to set a parameter defining the number of search results per page, ranging between ten and one hundred search resuIts per page. Other existing search technologies allow the user to search within a set of search results to further refine the pool of results generated by the search mechanism. Google also allows users to view search results in a new window while keeping the user's main search page open in the background.

Conventional search models address the number of results published on a single page, to a certain extent, or up to a certain number of results on a single page, as well as variations on how to display the search page with respect to the original search page, language preferences, and explicit content filtering. Conventional models also use the right handed scroll bar, mouse, or keyboard functions to scroll through the displayed results.

### SUMMARY OF THE INVENTION

Unfortunately, the existing conventional method of scrolling has certain limitations in distribution and deployment. For certain search results, generating a page of up to 100 results per page is not sufficient for a user to gain full access to the information. The right hand margin scroll bar, pagination tools, and mouse scroll are all fairly effective tools for sorting through the results, but are not maximized for a more precise searching experience that may provide a greater breadth of viewable search results in a shorter period of time. Further, the search results information does not work to generate new search results to the user on the fly based upon the user's scrolling behavior with the instant search results, or based upon a user's prior behavior in scrolling through search results. Also, the current publishing format in which search results are displayed, using only one straight line column, leaves little flexibility for the user to customize a results format that fits the preferred mode of operation for that specific user.

Accordingly, there is a need for a method to display search results that delivers the results in a customized fashion based upon the user's actions, and that delivers the results at a rate that is approximately the rate at which the user desires the results. The results also need a more efficient scrolling interface and content presentation that allows the user to examine the search results at a more rapid rate with enhanced scrolling, content availability, and publishing presentation features. The present invention calls for an enhanced scrolling interface to direct the sorting of search results. To maximize the effectiveness of the scrolling interface tool function, the scrolling tool is deployed in an environment where the results are served to the user as needed, with the search results being published in a unique way that allows the user to browse through the results in a way that enhances the efficiency and clarity of the process, and that is more visually and aesthetically pleasing.

An embodiment of the present invention is a system or method for retrieving and displaying search results by retrieving a user's search results from a database and providing an interface with which the user scrolls through the search results. The system or method approximates a rate at which the user will scroll through the search results based on at least one user action, and retrieves additional search results from the database based on the approximated rate. The system or method displays the search results on a display device in predetermined patterns of screen positions in cooperation with the navigation/scroll control interface. While the user scrolls through the search results, the system or method may retrieve additional search results from the database. The additional search results may be in the form of a continuous stream of search results. The scrolling interface may be provided as a graphical control on a web page, and may take the form of a circular wheel control, or scroll bar control, among others. The rate at which search results are displayed may be approximated based on the user reaching a certain point in the search results, or based on the user's past browsing behavior. The search results may be displayed in a horizontal, circular, or chained column fashion, among other patterns of screen positions. While displaying the search results, the system or method may emphasize at least one of the search results based on its displayed position on the display device, for instance, a search result that is displayed in the center of the display device may be enlarged.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates two types of graphical scrolling interface controls employed in embodiments of the present invention.

FIG. 2 illustrates a graphical scrolling interface of the present invention where search results are displayed in a horizontal manner and are controlled by a scroll bar control.

FIG. 3 illustrates a graphical scrolling interface of the present invention where search results are displayed in a horizontal manner and are controlled by a circular control.

FIG. 4 illustrates a graphical scrolling interface of the present invention where search results are displayed in linked columns and are controlled by a scroll bar control.

FIG. 5 illustrates a graphical scrolling interface of the present invention where search results are displayed in linked columns and are controlled by a circular control.

FIG. 6 illustrates a graphical scrolling interface of the present invention where search results are displayed in a circular manner and are controlled by a scroll bar control.

FIG. 7 illustrates a graphical scrolling interface of the present invention where search results are displayed in a circular manner and are controlled by a circular control.

FIG. 8 is a flow diagram of one embodiment of the present invention,

FIG. 9 is a schematic view of a computer network in which embodiments of the present invention operate.

FIG. 10 is a block diagram of a computer node/device in the network of FIG. 9.

### DETAILED DESCRIPTION OF THE INVENTION

A description of example embodiments of the invention follows.

The present invention, in accordance with one embodiment relates to the creation of a system in which data results from a search or query can be browsed through by the end user in an efficient, logical, and user friendly manner. The system contemplates that search results will be able to be scrolled through with not just a mouse wheel, right margin arrow, or pull down block, but also with a graphical control published onto a web page. The graphical control's manipulation allows for the rapid display of results in various graphical templates, in various modes of graphical features, and with enhancement of specific search results.

By utilizing a circular graphical wheel control or bar control, a user can quickly browse through a search engine's results from start to finish. Moreover, the search result pages can be generated in a manner where typical pagination methods are disregarded or combined with new methods. These methods include the programming of triggers to generate new pages upon the user reaching a certain point in the search results, (egg., a bottom point on a search result page), or when the user has shown a propensity in the past to search multiple pages. The search result display server can automatically queue the search page results based upon learned user behavior. Also, instead of queuing a maximum of 100 results, the search engine can queue upwards of 500 results, enabling the new scrolling mechanism and graphical display to optimize their efficiency for the user. Another element of this embodiment includes the possibility of serving a continuous stream of results. This kind of linked stream is common for sport sites like MLB.com and online stock tickers where streamed elements contain links that then pass the user to a meta data page related to the link. In this embodiment, the graphical scroll interface can speed or slow the tempo of the scroll based upon user preference.

The manner in which the search results are displayed on the screen will be able to be customized by the user to present the data in a variety of formats, including the traditional straight line up-and-down format, but also in a manner that scrolls from right-to-left, up-and-down (top down) in chained columns (rows), or in a circular (or spiral) or other looping fashion. In addition, the scroll may emphasize one or more search results in a specific position in the scroll or on the display screen, such as but not limited to, making the result in the middle of the screen a larger sized text, or in bold type. This position may be customized by the user, as the position in the display may also be the far left hand result on the display screen, or the top or bottom result on the screen.

The graphical scroll interface may be a circular wheel type interface activated through a mouse control, and may be published on a web page using standard software publishing tools, such as Flash or HTML, that enable graphical controls to be manipulated by a mouse, touch screen, or other input device. As the graphical wheel interface is activated by a held down mouse click for example, the user may spin the circular control clockwise or counter-clockwise to browse through search results.

Search results compiled in a stream move fluidly across the page while search results generated in HTML or Flash intermittently serve new pages. The rate at which the search results are generated depends upon how many results are served onto a page, how many results are generated by the search engine, at what pace the user scrolls the graphical interface, and what known connecting technologies or rate processing techniques are employed.

The scrolling interface may also be manipulated via a touch screen system. In this embodiment the circular scroll wheel functions in a similar manner as Apple's iPod circular scroll function, except rather than being utilized on a portable hardware device, the circular scroll wheel is used by the user of a personal computer or other display screen. A more traditional horizontal or vertical scroll bar control may be used in place of the circular wheel, but will serve the same purpose of browsing through the results with ease, The graphical interface is programmed to move the scroll in increments of one result unit at a time, thus it is possible to scroll through the results one by one, or to scroll through thousands of results using the interface to fast forward or rewind. Upon a fast forward, or rewind, the interface is programmed to tell the server how many places to skip ahead, or back, based upon the user's manipulation of the scrolling interface.

In one circular scroll embodiment, each search result corresponds to a single degree on the circular interface, thus each complete circular rotation of the graphical interface corresponds to 360 results for example. During the manipulation of the interface by the user, the user may pause at a particular point in the search results. When the user pauses, that particular point is sent to the search results database to be configured for the user. While scrolling though search results, the number of search results is displayed on the display screen as well as the user's current position in the search results (e.g., “Result 438 out of 10,887”) using known pagination techniques.

The system works well not only for search engine results but for non-online results as well. The system may be used to comb through existing files on a computer, such as data, music, or video files. The system also works particularly well for combing through video results, as often times the initial image of a video file is all a user needs to see in order to determine if the video is something of interest. Since the system moves through frames of data and single results with great speed, it enables a large number of results to be viewed in a small amount of time. The various scrolling and data presentation methods may emphasize search results in a specific screen position, which enables the user to have an enhanced view of a video frame, picture thumbnail, or the like to determine if the characteristics of the single frame or thumbnail warrant a greater inspection via user selection (e.g., a click selection) or text perusal.

This method requires each text result to be coded for the scrolling control mechanism as the mechanism will be capable of moving search results one unit at a time. The benefit to coding each result is that all results within a database that are available for search within the search engine database structure can receive this programming update as a one time add-on. The programming may be applied either retroactively for existing data, or may be applied to new data being added to the search engine's available searchable content database system.

The manner in which the search result content is displayed is a program publishing issue. Program publishing is formatting that is undertaken as a programming rule that is applied to every search result in the database as the specific format in which the information is requested. The formatting may be a default set by the user to be called upon by the search engine data content serving system. In an HTML or Flash format, search results may be rotated in and around a single page until all the search results, say 500 results, or fewer or greater numbers of results, have been viewed by the user. At the time at which the all results have been viewed, the user may manually request the next page of results, or the next set of results be served in an automated manner. Such an automated manner may serve the next page of results at the end of the 500 results (or fewer or greater) automatically based upon the viewing position of the last search result, e.g., activating the next set of 500 results automatically when the last result in the first set of 500 results has been viewed.

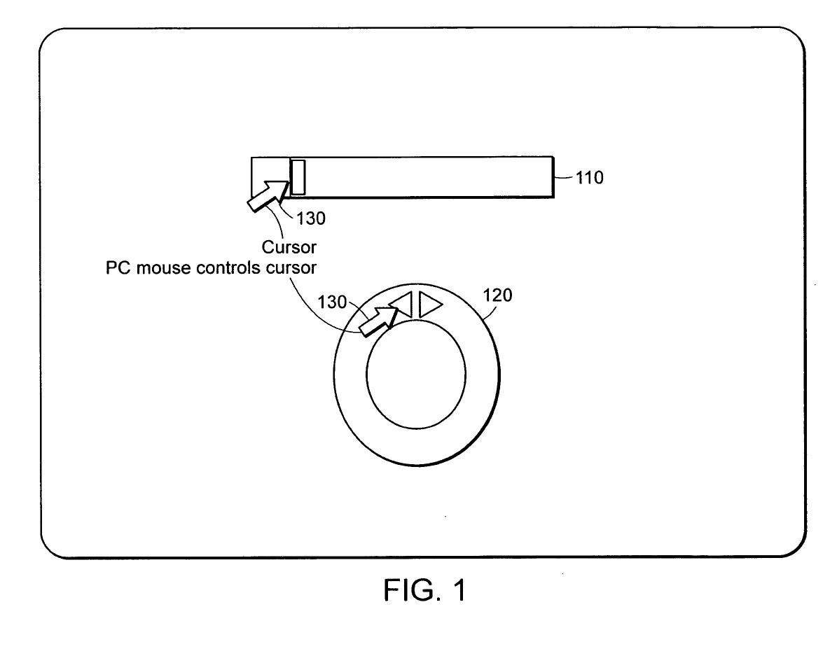

FIG. 1 illustrates two types of graphical scrolling interface controls employed in embodiments of the present invention. The first is a traditional scroll bar control 110 and the second is a circular control 120. Each of the controls may be manipulated by a cursor 130 controlled by a mouse, by a finger or pointing device on a touch screen display (not shown), or other user input device.

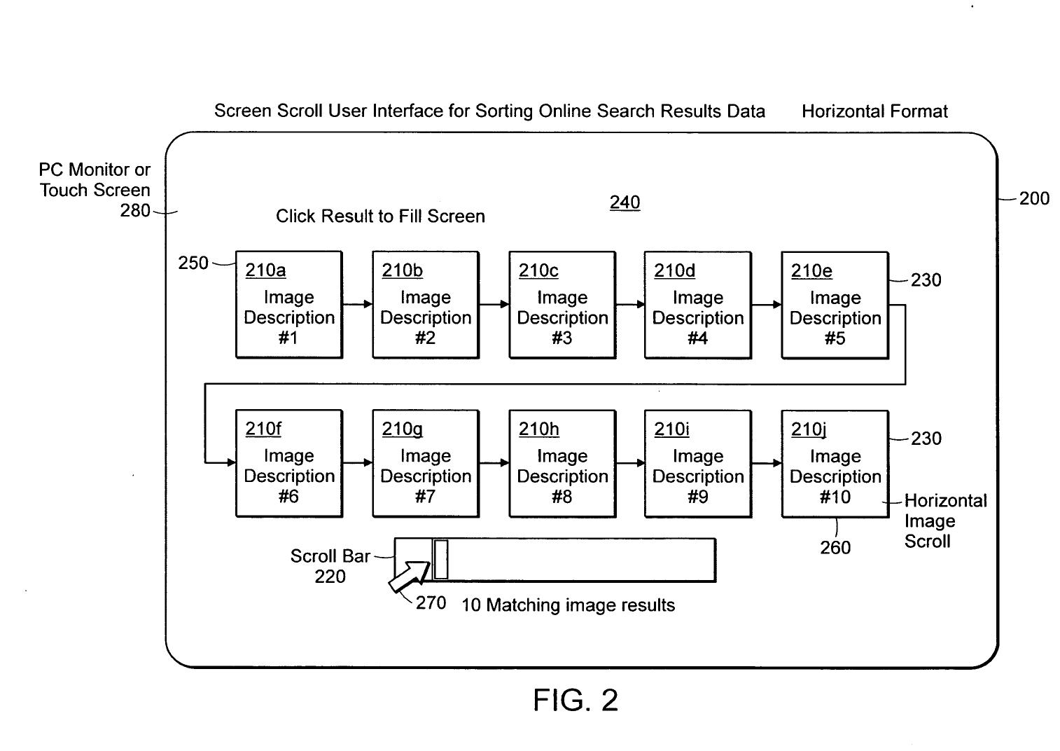

FIG. 2 illustrates a graphical scrolling interface 200 where search results 210 are displayed in a horizontal manner (e.g., left-to-right, top row down sequence) and are controlled by a scroll bar control 220. In this embodiment, the search results 210 are displayed in a number of rows 230. The scrolling interface fills the display area 240 with either a predetermined number of results, or with as many results that will fit in the area. Using the scroll bar control 220, a user may browse through the search results 210, whereupon the displayed search results 210a-j move from left to right, row by row (indicated by the arrows). While the displayed results are moved off the display screen in the lower-right corner position 260, new search results enter the screen at the upper-left corner position 250. The movement rate of the search results corresponds to the rate at which the user moves the scroll bar control 220. The new search results that enter at the upper-left corner position 250 are cached at a rate that is approximated based on the user's action, such as the current rate at which the user scrolls through the results. The caching rate may also be approximated based on the user's past browsing behavior (heuristics). The user may manipulate the scroll bar control 220 with a cursor 270 on a PC monitor 280, or with a finger or pointing device (not shown) on a touch screen display 280 for example. To browse forward through the search results 210, the user moves the cursor 270 or pointing device to the right along the scroll bar control 220, and to browse backward through the results 210, the user moves the cursor 270 or pointing device to the left along the scroll bar control 220. At any point during the user's browsing, the user may select a search result 210 to expand that result such that it fills the display area 240.

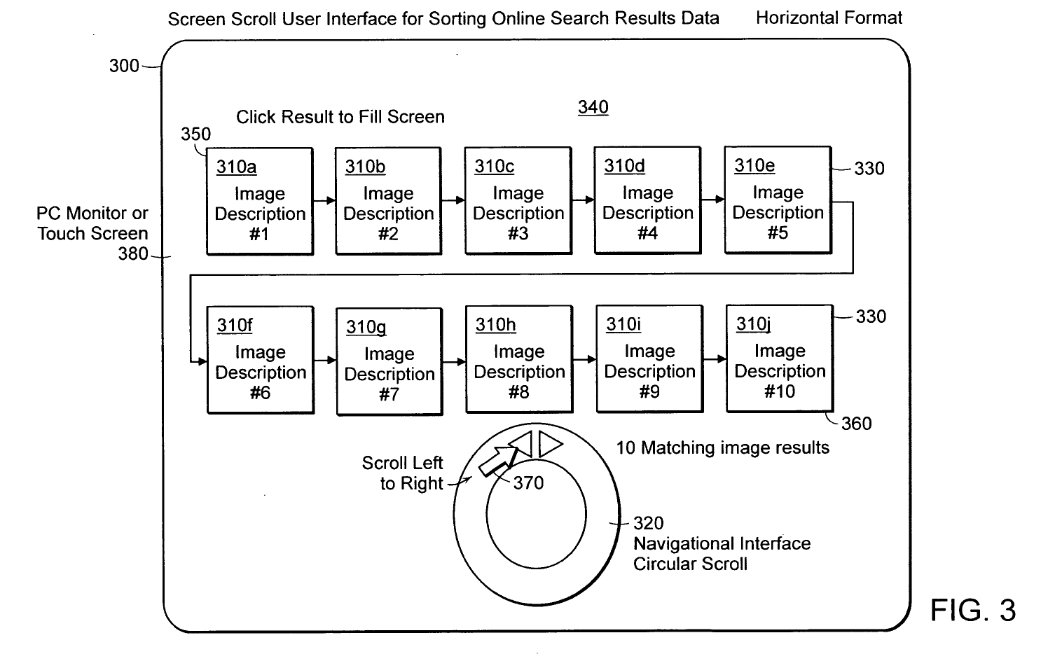

FIG. 3 illustrates a graphical scrolling interface 300 where search results 310 are displayed in a horizontal manner (e.g., left-to-right, top row down sequence) and are controlled by a circular control 320. In this embodiment, the search results 310 are displayed in a number of rows 330. The scrolling interface fills the display area 340 with either a predetermined number of results, or with as many results that will fit in the area. Using the circular control 320, a user may browse through the search results 310, whereupon the displayed search results 310a-j move from left to right, row by row (indicated by the arrows). While the displayed results are moved off the display screen in the lower-right corner position 360, new search results enter the screen at the upper-left corner position 350. The movement rate of the search results corresponds to the rate at which the user moves the circular control 320. The new search results that enter at the upper-left corner position 350 are cached at a rate that is approximated based on the user's action, such as the current rate at which the user scrolls through the results. The caching rate may also be approximated based on the user's past browsing behavior. The user may manipulate the circular control 320 with a cursor 370 on a PC monitor 380, or with a finger or pointing device (not shown) on a touch screen display 380 for example. To browse forward through the search results 310, the user may click (select) the right arrow of the circular control with the cursor 370 or may move the pointing device clockwise around the circular control 320. Likewise, to browse backward through the results 310, the user may click (select) the left arrow of the circular control with the cursor 370 or may move the pointing device counter-clockwise around the circular control 320. At any point during the user's browsing, the user may select a search result 310 to expand that result such that it fills the display area 340.

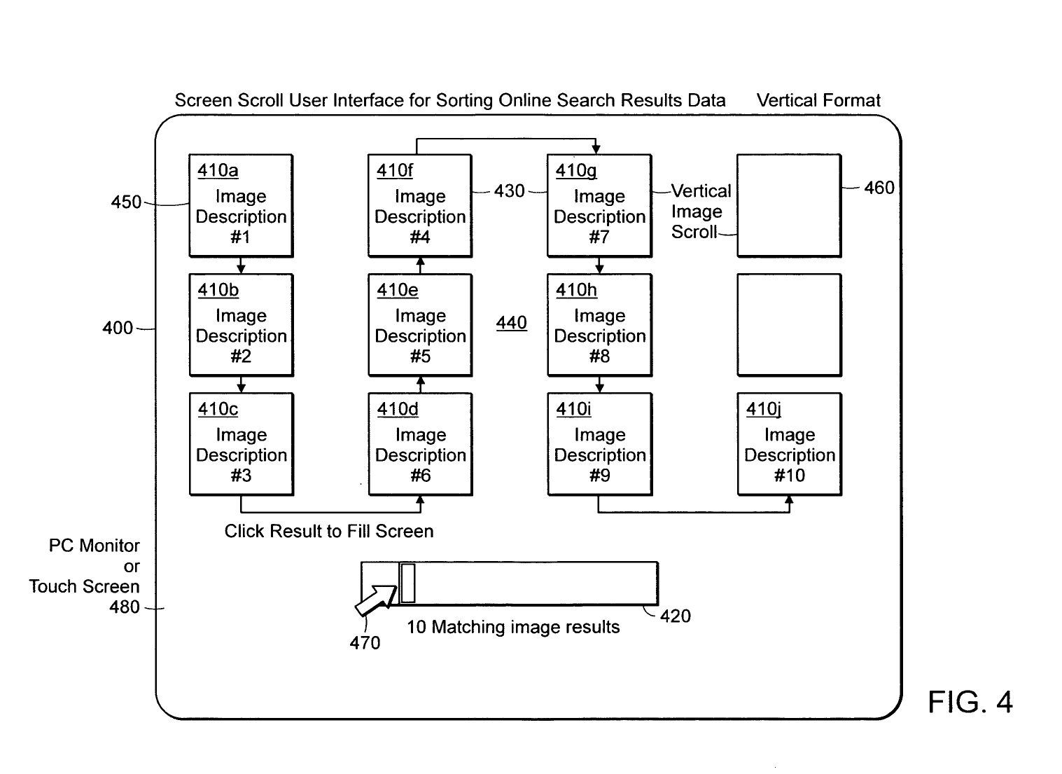

FIG. 4 illustrates a graphical scrolling interface 400 where search results 410 are displayed in vertically linked columns and are controlled by a scroll bar control 420. In this embodiment, the search results 410 are displayed in a number of vertically linked columns 430. The scrolling interface fills the display area 440 with either a predetermined number of results, or with as many results that will fit in the area. Using the scroll bar control 420, a user may browse through the search results 410, whereupon the displayed search results 410a-j move from top-to-bottom or from bottom-to-top within the columns, and from left-to-right across the different columns (indicated by the arrows). While the displayed results are moved off the display screen in the upper-right corner position 460, new search results enter the screen at the upper-left corner position 450 for example. The movement rate of the search results corresponds to the rate at which the user moves the scroll bar control 420. The new search results that enter at the upper-left corner position 450 are cached at a rate that is approximated based on the user's action, such as the current rate at which the user scrolls through the results. The caching rate may also be approximated based on the user's past browsing behavior. The user may manipulate the scroll bar control 420 with a cursor 470 on a PC monitor 480, or with a finger or pointing device (not shown) on a touch screen display 480 for example. To browse forward through the search results 410, the user moves the cursor 470 or pointing device to the right along the scroll bar control 420, and to browse backward through the results 410, the user moves the cursor 470 or pointing device to the left along the scroll bar control 420. At any point during the user's browsing, the user may select a search result 410 to expand that result such that it fills the display area 440.

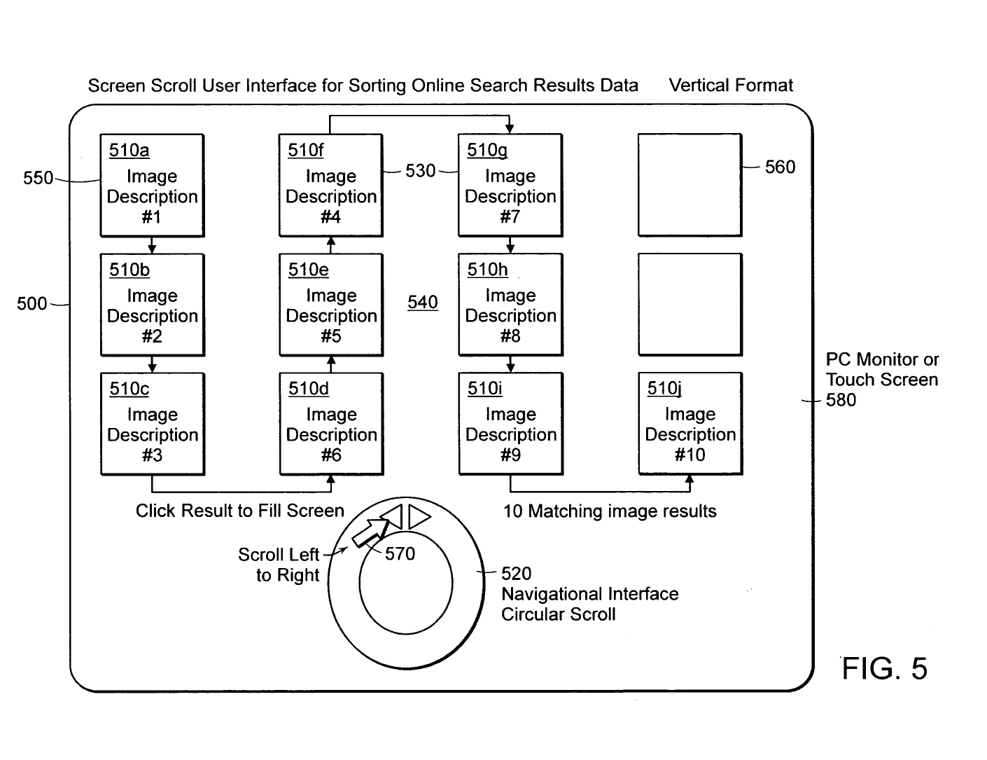

FIG. 5 illustrates a graphical scrolling interface 500 where search results 510 are displayed in linked columns and are controlled by a circular control 520. In this embodiment, the search results 510 are displayed in a number of vertically linked columns 530. The scrolling interface fills the display area 540 with either a predetermined number of results, or with as many results that will fit in the area. Using the scroll bar control 520, a user may browse through the search results 510, whereupon the displayed search results 510i a-j move from top-to-bottom or from bottom-to-top within the columns, and from left-to-right across the different columns (indicated by the arrows). While the displayed results are moved off the display screen in the upper-right corner position 560, new search results enter the screen at the upper-left corner position 550 for example. The movement rate of the search results corresponds to the rate at which the user moves the circular control 520. The new search results that enter at the upper-left corner position 550 are cached at a rate that is approximated based on the user's action, such as the current rate at which the user scrolls through the results. The caching rate may also be approximated based on the user's past browsing behavior. The user may manipulate the circular control 520 with a cursor 570 on a PC monitor 580, or with a finger or pointing device (not shown) on a touch screen display 580 for example. To browse forward through the search results 510, the user may click (select) the right arrow of the circular control with the cursor 570 or may move the pointing device clockwise around the circular control 520. Likewise, to browse backward through the results 510, the user may click (select) the left arrow of the circular control with the cursor 570 or may move the pointing device counter-clockwise around the circular control 520. At any point during the user's browsing, the user may select a search result 510 to expand that result such that it fills the display area 540.

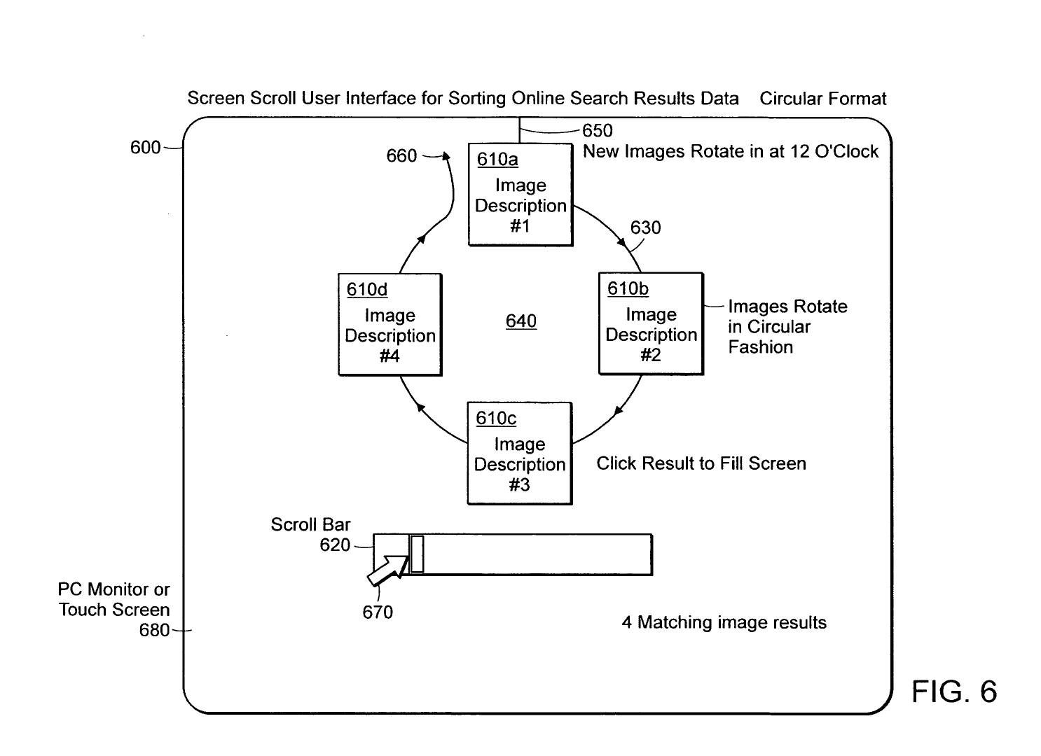

FIG. 6 illustrates a graphical scrolling interface 600 where search results 610 are displayed in a circular manner and are controlled by a scroll bar control 620. In this embodiment, the search results 610 are displayed along a circular path 630. The scrolling interface fills the display area 640 in a circular manner with either a predetermined number of results, or with as many results that will fit in the area. Using the scroll bar control 620, a user may browse through the search results 610, whereupon the displayed search results 610a-d move clockwise for example along the circular path 630 (indicated by the arrows). While the displayed results are moved off the top 660 of the display screen, new search results enter the screen at the 12 o'clock position 650. The movement rate of the search results corresponds to the rate at which the user moves the scroll bar control 620. The new search results that enter at the 12 o'clock position 650 are cached at a rate that is approximated based on the user's action, such as the current rate at which the user scrolls through the results. The caching rate may also be approximated based on the user's past browsing behavior. The user may manipulate the scroll bar control 620 with a cursor 670 on a PC monitor 680, or with a finger or pointing device (not shown) on a touch screen display 680 for example. To browse forward through the search results 610, the user moves the cursor 670 or pointing device to the right along the scroll bar control 620, and to browse backward through the results 610, the user moves the cursor 670 or pointing device to the left along the scroll bar control 620. At any point during the user's browsing, the user may select a search result 610 to expand that result such that it fills the display area 640.

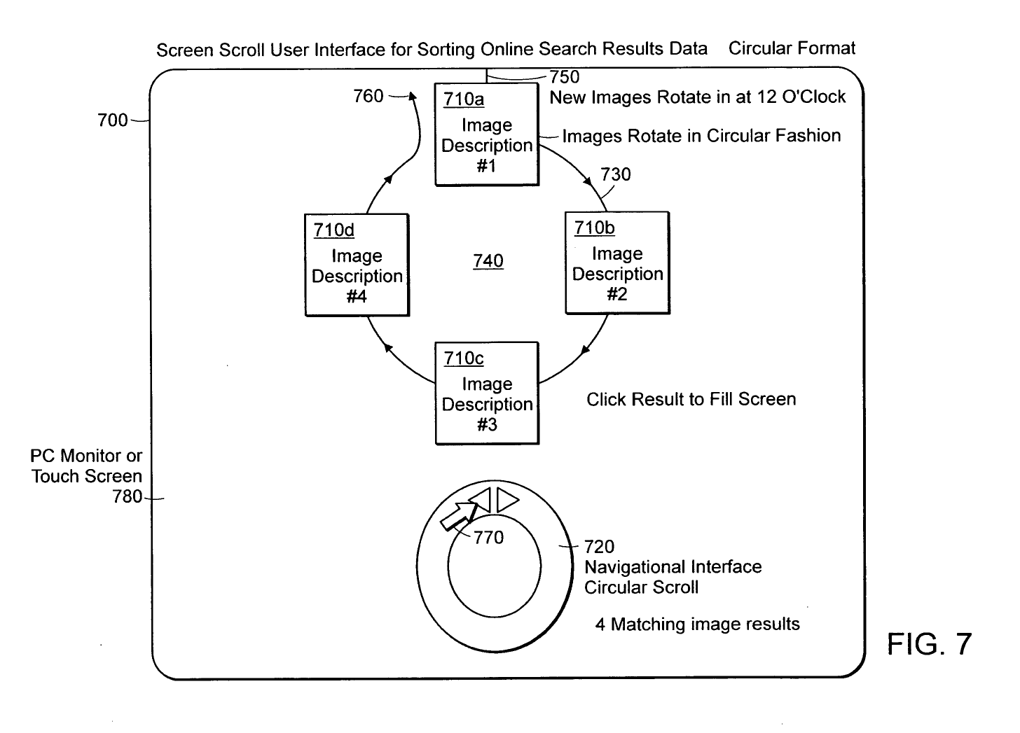

FIG. 7 illustrates a graphical scrolling interface 700 where search results 710 are displayed in a circular manner and are controlled by a circular control 720. In this embodiment, the search results 710 are displayed along a circular path 730. The scrolling interface fills the display area 740 in a circular manner with either a predetermined number of results, or with as many results that will fit in the area. Using the scroll bar control 720, a user may browse through the search results 710, whereupon the displayed search results 710a-d move clockwise along the circular path 730 (indicated by the arrows). While the displayed results are moved off the top 760 of the display screen, new search results enter the screen at the 12 o'clock position 750. The movement rate of the search results corresponds to the rate at which the user moves the circular control 720. The new search results that enter at the 12 o'clock position 750 are cached at a rate that is approximated based on the user's action, such as the current rate at which the user scrolls through the results. The caching rate may also be approximated based on the user's past browsing behavior. The user may manipulate the circular control 720 with a cursor 770 on a PC monitor, or with a finger or pointing 20 device (not shown) on a touch screen display 780 for example. To browse forward through the search results 710, the user may click (select) the right arrow of the circular control with the cursor 770 or may move the pointing device clockwise around the circular control 720. Likewise, to browse backward through the results 710, the user may click (select) the left arrow of the circular control with the cursor 770 or may move the pointing device counter-clockwise around the circular control 720. At any point during the user's browsing, the user may select a search result 710 to expand that result such that it fills the display area 740.

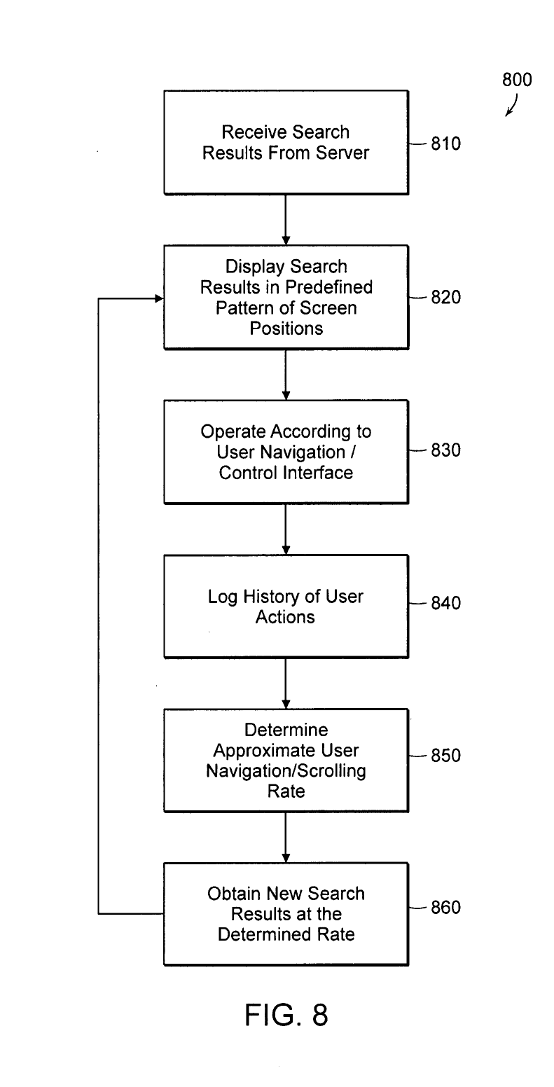

FIG. 8 is a flow diagram illustrating the steps for retrieving and displaying search results according to one embodiment of the present invention. In step 810, the system 800 receives search results from the search result server and caches them in memory. The search results are then displayed in a predetermined pattern of positions on a display screen in step 820 as described above in FIGS. 2-7. In step 830, the system 800 operates according to, or in response to, a user's navigation or use of a scrolling control interface as discussed above. The system 800 then logs a history of the user's actions in step 840. Based on the history of the user actions, the system 800 determines an approximate rate of the user's navigation or scrolling in step 850, and retrieves new search results at the determined rate in step 860. The loop in FIG. 8 indicates that steps 820, 830, 840, 850, 860 continually support user interaction with the search results.

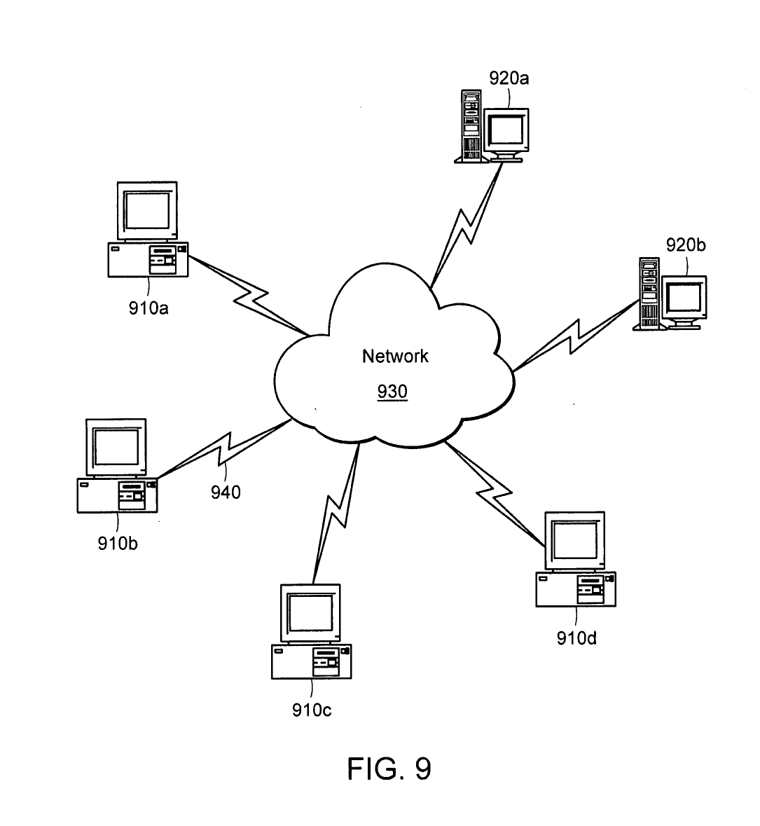

FIG. 9 is a schematic view of a computer network in which embodiments of the present invention operate. Client devices 910 and server devices 920 provide processing, storage, and input/output devices executing application programs and the like. Client devices 910 can also be linked through a communications network 930 to other computing devices, including other client devices 910 and server devices 920. The communications network 930 may be part of a remote access network, a global network (e.g., the Internet), a worldwide collection of computing devices, local area or wide area networks, and gateways that currently use respective protocols (TCP/IP, Bluetooth, etc.) to communicate with one another. Other electronic device/computer network architectures are also suitable.

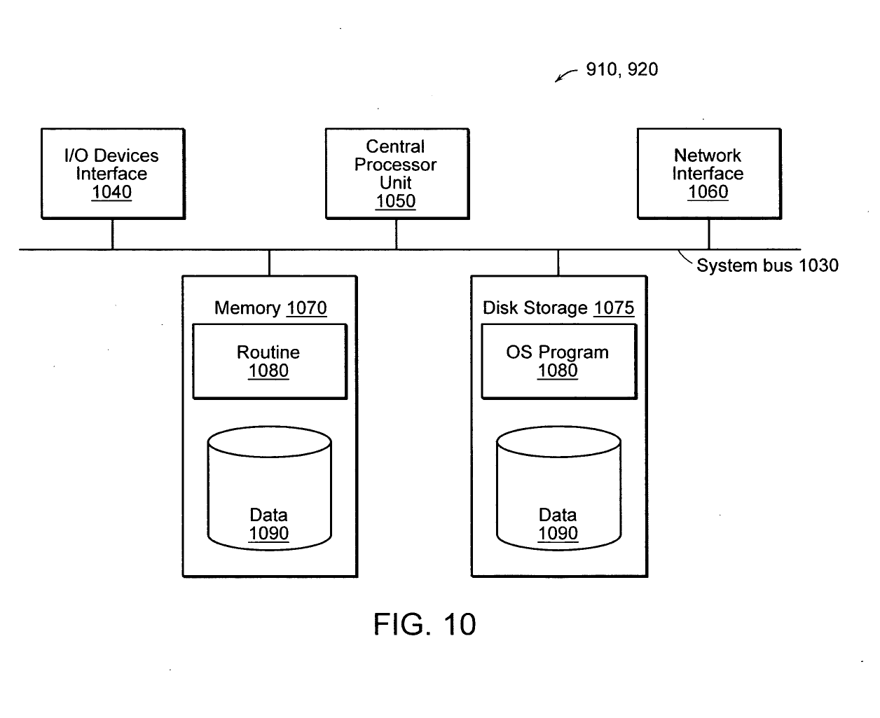

FIG. 10 is a block diagram of a computer node/device 910, 920 in the network of FIG. 9. Each device 910, 920 contains a system bus 1030, where a bus is a set of hardware lines used for data transfer among the components of a device or processing system. The bus 1030 is essentially a shared conduit that connects different elements of a device (e.g., processor, disk storage, memory, input/output ports, network ports, etc.) that enables the transfer of information between the elements. Attached to the system bus 1030 is an I/O device interface 1040 for connecting various input and output devices (e.g., keyboard, mouse, displays, printers, speakers, etc.) to the device 910, 920. A network interface 1060 allows the device to connect to various other devices attached to a network (e.g., network 930 of FIG. 9). Memory 1070 provides volatile storage for computer software instructions 1080 and data 1090 used to implement an embodiment of the present invention (e.g., the database search result user interfaces detailed above in FIGS. 1-7 and the method/process detailed above in FIG. 8). Disk storage 1075 provides non-volatile storage for computer software instructions 1080 and data 1090 used to implement an embodiment of the present invention. Central processor unit 1050 is also attached to the system bus 1030 and provides for the execution of computer instructions.

In one embodiment, the processor routines 1080 and data 1090 are a computer program product (generally referenced 1080), including a computer readable medium (e.g., a removable storage medium such as one or more DVD-ROM's, CD-ROM's, diskettes, tapes, etc.) that provides at least a portion of the software instructions for the invention system. Computer program product 1080 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 940 (FIG. 9) embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 1080.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 1080 is a propagation medium that the device 910 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to example embodiments thereof, it will be understood by those skilled in the art that various changes in form and details may be made therein without departing from the scope of the invention encompassed by the appended claims. For example, other patterns of display similar to the circular fashion of FIGS. 6 and 7 are suitable. The search results may be displayed along a spiral path, and other loop shapes may be rectangular or other polygonal shaped paths.

What is claimed is:

1. A method for retrieving and displaying search results, the method comprising:
retrieving a user's search results from a database;
providing an interface with which the user scrolls through the search results in a given pattern of screen positions;
approximating a rate at which the user will scroll through the search results based on at least one user action;
displaying the search results on a display device set in the given pattern of screen positions; and
retrieving additional search results from the database based on the approximated rate.

2. The method of claim 1 wherein retrieving additional search results includes retrieving the additional search results while the user scrolls through the original search results.

3. The method of claim 2 wherein retrieving additional search results includes retrieving a continuous stream of search results.

4. The method of claim 1 wherein providing an interface includes providing a graphical control on a web page.

5. The method of claim 4 wherein the graphical control is a circular wheel control.

6. The method of claim 4 wherein the graphical control is a scroll bar control.

7. The method of claim 1 wherein approximating a rate based on at least one user action includes approximating a rate based on the user reaching a certain point in the search results.

8. The method of claim 1 wherein approximating a rate based on at least one user action includes approximating a rate based on the user's past browsing behavior.

9. The method of claim 1 wherein the given pattern of screen positions is a circular pattern.

10. The method of claim 1 wherein the given pattern of screen positions is a chained column pattern.

11. The method of claim 1 wherein displaying the search results includes emphasizing at least one of the search results based on its displayed position on the display device.

12. The method of claim 11 wherein displaying the search results includes enlarging a search result if it is displayed in the center of the display device.

13. A graphical scrolling system for displaying search results, comprising:
memory to store a user's cached search results;
an interface to scroll through the search results;
logic to approximate a rate at which the user will scroll through the results based on at least one user action; and
a display device to display the search results at the approximated rate.

14. The system of claim 13 further comprising:
memory to store additional search results while the user scrolls through the original search results.

15. The system of claim 14 wherein the additional search results are a continuous stream of search results,

16. The system of claim 13 wherein the interface is a graphical control on a web page.

17. The system of claim 16 wherein the interface is a circular wheel control.

18. The system of claim 16 wherein the interface is a scroll bar control.

19. The system of claim 13 wherein the logic approximates a rate based on the user reaching a certain point in the search results.

20. The system of claim 13 wherein the logic approximates a rate based on the user's past browsing behavior.

21. The system of claim 13 wherein the display device displays the search results in a circular fashion.

22. The system of claim 13 wherein the display device displays the search results in a chained column fashion.

23. The system of claim 13 wherein the display device emphasizes at least one of the search results based on its displayed position on the display device.

24. The system of claim 23 wherein the display device enlarges a search result if it is displayed in the center of the display device.
